(19) United States
(12) Patent Application Publication
(10) Pub. No.: US 2007/0128019 A1
(43) Pub. Date: Jun. 7, 2007

(54) BLOWER

(75) Inventors: CHIH-HANG CHAO, Tu-Cheng (TW); YU-HSU LIN, San Jose, CA (US); JENG-DA WU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,422

(22) Filed: Aug. 4, 2006

(30) Foreign Application Priority Data
Dec. 3, 2005 (CN) 200510102096.3

(51) Int. Cl. F03B 3/16

(52) U.S. Cl. 415/204

(57) ABSTRACT

A blower includes a scroll housing and a damping rib. The scroll housing includes a body portion for guiding air, a hopper portion for discharging the air through an outlet, and a recess formed between the body portion and the hopper portion. The damping rib is adjacent to the recess connecting the body portion with the hopper portion to enhance structural integrity of the scroll housing.

### FIELD OF THE INVENTION

The present invention relates to a blower, and particularly to a blower for dissipating heat from electronic devices.

### DESCRIPTION OF RELATED ART

Electronic devices such as central processing units (CPUs) frequently generate large amounts of heat during normal operation, which can destabilize operation of the electronic device and possibly cause damage. Oftentimes, a heat dissipation assembly is used to dissipate heat from the electronic device. The heat dissipation assembly frequently comprises a fan facilitating removal of heat from the electronic device.

As computer technology continues to advance, the electronic devices of computers are being made to provide faster operational speeds and greater functional capabilities, which cause more heat to be generated. Therefore, high-speed blowers are used to dissipate the generated heat instead of ordinary fans. FIG. 3 shows a conventional blower. The blower includes a scroll housing 40. The scroll housing 40 includes a body portion 40a for guiding air, a hopper portion 40b for discharging the air through an outlet 44, and a recess 40c formed between the body portion 40a and the hopper portion 40b. The blower works at high speed to provide greater airflow, however, with greater speed comes greater noise.

What is needed, therefore, is a high-speed blower with a reduced noise level.

### SUMMARY OF THE INVENTION

A high-speed blower with reduced noise is provided. In a preferred embodiment, the blower includes a scroll housing and a damping rib, the scroll housing having a bottom panel, a lid, side panels, and an outlet, the scroll housing defining a body portion for guiding air, a hopper portion for discharging the air through the outlet, and a recess formed at a boundary between the body portion and the hopper portion, the damping rib being adjacent to the recess and extending from a side panel of the body portion to a side panel of the hopper portion.

Other advantages and novel features will become more apparent from the following detailed description when taken in conjunction with the accompanying drawings, in which:

### BRIEF DESCRIPTION OF THE DRAWINGS

FIG. 1 is an isometric view of a blower, in accordance with a preferred embodiment of the present invention;

FIG. 2 is an exploded view of the blower of FIG. 1; and

FIG. 3 is an isometric view of a conventional blower.

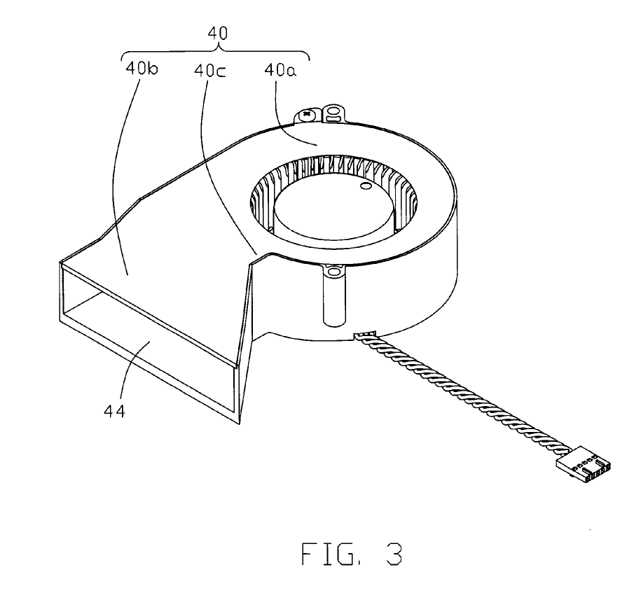

### DETAILED DESCRIPTION OF THE INVENTION

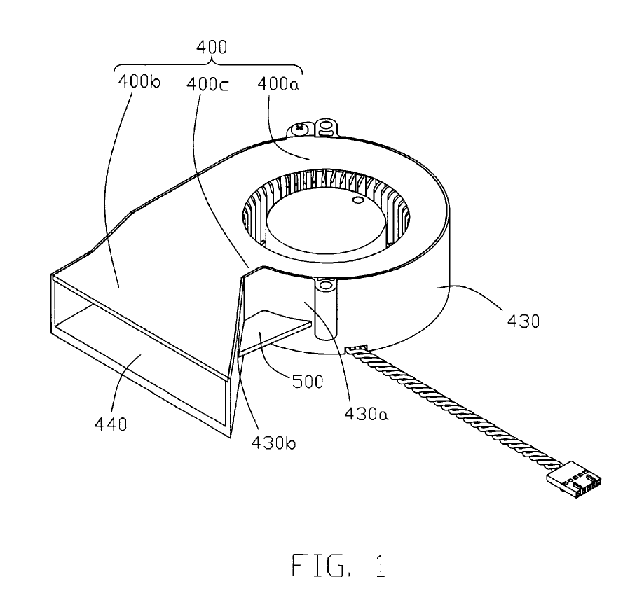

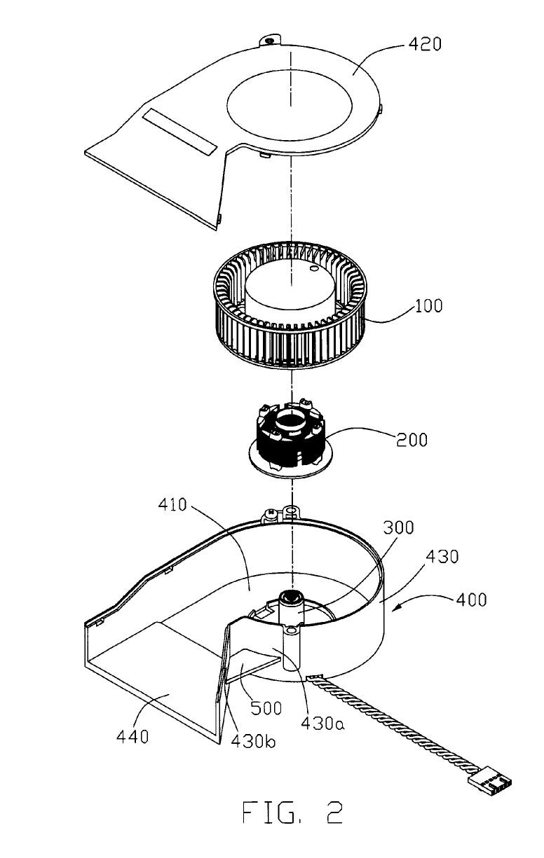

Referring to FIG. 1 and FIG. 2, a blower in accordance with a preferred embodiment of the present invention includes a fan blade assembly 100, a rotor 200, a stator 300, a scroll housing 400, and a damping rib 500. The scroll housing 400 has a bottom panel 410, a lid 420, side panels 430, and an outlet 440. The scroll housing 400 defines a body portion 400a for guiding air, a hopper portion 400b for discharging the air through the outlet 440, and a recess 400c formed between the body portion 400a and the hopper portion 400b. The damping rib 500 is adjacent to the recess 400c extending from a side panel 430a of the body portion 400a to a side panel 430b of the hopper portion 400b. The stator 300 is secured on the bottom panel 410 of the scroll housing 400. The rotor 200 is rotatably placed around the stator 300. The fan blade assembly 100 is secured around the rotor 200. The damping rib 500 enhances structural integrity of the scroll housing 400 thereby acting as a vibration damper of the scroll housing 400 when the blower operates at high-speed.

It is believed that the present invention and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A blower comprising:
a scroll housing having a bottom panel, a lid, side panels, and an outlet, the scroll housing defining:
a body portion for guiding air;
a hopper portion for discharging the air through the outlet; and
a recess formed between the body portion and the hopper portion; and
a damping rib adjacent to the recess extending from a side panel of the body portion to a side panel of the hopper portion.

2. The blower as claimed in claim 1, further comprising a stator secured on the bottom panel of the scroll housing.

3. The blower as claimed in claim 2, further comprising a rotor rotatably placed around the stator.

4. The blower as claimed in claim 3, further comprising a fan blade assembly secured around the rotor.

5. A blower comprising:
a scroll housing, the scroll housing comprising:
a body portion for guiding air;
a hopper portion for discharging the air through an outlet; and
a recess formed between the body portion and the hopper portion; and
a damping rib adjacent to the recess connecting the body portion with the hopper portion.

6. The blower as claimed in claim 5, further comprising a stator secured on a bottom panel of the scroll housing.

7. The blower as claimed in claim 6, further comprising a rotor rotatably placed around the stator.

8. The blower as claimed in claim 7, further comprising a fan blade assembly secured around the rotor.
